(19) United States
(12) Patent Application Publication
(10) Pub. No.: US 2015/0102791 A1
(43) Pub. Date: Apr. 16, 2015

(54) VOLTAGE REGULATOR CALIBRATION

(71) Applicant: Intel Corporation, Santa Clara, CA (US)

(72) Inventors: Nazar S. Haider, Fremont, CA (US); Hendra Rustam, Santa Clara, CA (US)

(73) Assignee: INTEL CORPORATION, Santa Clara, CA (US)

(21) Appl. No.: 14/576,471

(22) Filed: Dec. 19, 2014

Related U.S. Application Data
(63) Continuation-in-part of application No. PCT/US13/48774, filed on Jun. 28, 2013.

(51) Int. Cl. G05F 1/46

(52) U.S. Cl. CPC G05F 1/46
USPC 323/281

(57) ABSTRACT

The present disclosure describes a circuit for managing power and heat. The circuit includes a voltage regulator, and a calibration module comprising logic, at least partially comprising hardware logic. The calibration module is configured to identify a first voltage of the circuit when a current is not provided to the voltage regulator, and determine a second voltage of the circuit when a current is provided to the voltage regulator during a reset sequence. The calibration module is further configured to compare the first voltage to the second voltage.

### CROSS REFERENCE TO RELATED APPLICATIONS

The present application claims priority as a continuation in part to Patent Application No. PCT/US13/48774, filed Jun. 28, 2013, which is incorporated herein by reference.

### BACKGROUND

The number of cores has rapidly increased for each new generation of servers, thanks to a constantly growing need for improved server performance. However, the total power envelope for each generation of servers has not changed. Power management is used to control and reduce power usage so that the server delivers optimal performance and the power supply does not get overloaded.

### BRIEF DESCRIPTION OF THE FIGURES

The following detailed description may be better understood by referencing the accompanying drawings, which contain specific examples of numerous objects and features of the disclosed subject matter.

FIG. 1 is a block diagram of a system for power management and delivery in an electronic device.

FIG. 2 is a graph illustrating the relationship between voltage and current in a power detector circuit.

FIG. 3 is a diagram of an embodiment of a calibration module that may be used in power detector circuit.

FIG. 4 is a process flow diagram of a method for voltage regulator calibration.

FIG. 5 is a block diagram depicting an example of a computer-readable medium configured to implement calibration.

### DETAILED DESCRIPTION

The present disclosure is related to calibration of a voltage regulator. In some cases, calibration of a voltage regulator may be useful within thermal management and platform level power management in an electronic device.

Thermal design power (TDP) represents the amount of power dissipated when a CPU is running at its nominal frequency while running the highest power real world application. Maximum application power (Pₐₚₚ) represents the maximum amount of power dissipated when the CPU is running non-virus applications, which can occur when the CPU is overclocked or in Turbo. Maximum power (Pₘₐₓ) is a power specification that refers to the absolute maximum power dissipated by the CPU during operation. A power virus is a malicious computer program that is coded to maximize CPU power dissipation (or thermal energy output), causing the electronic device to overheat over time. A power virus can cause the CPU to operate at Pₘₐₓ. Pₘₐₓ can be several times greater than TDP, and may be substantially greater than Pₐₚₚ. Pₘₐₓ is not sustainable by the server platform's power supply.

With each successive generation of server platform, the number of cores has increased, leading to a steep increase in Pₘₐₓ in relation to TDP. As Pₘₐₓ increases with each generation, so does the demand for larger power supplies and larger bulk caps on the server platform's motherboard to handle Pₘₐₓ conditions. This is a trend that is not sustainable due to the real estate and infrastructure required. By improving feedback time between the server platform's power supply and CPU, the Pₘₐₓ condition can be detected and remedied more quickly. As the CPU spends less time operating in Pₘₐₓ, the need for larger and more expensive bulk caps is reduced.

A power detector circuit in an electronic device can control the amount of power dissipated by a CPU in operation and reduce thermal output in order to prevent overheating. The power detector circuit can measure voltage at a sensing point, and determine if a certain power condition has been reached. A power condition can refer to a level of power dissipated by a central processing unit (CPU) during operation. If the power condition has been reached, the power detector circuit can send out an alert to reduce power production. By measuring voltage, the power detector circuit can provide fast feedback (within a few microseconds) that the power condition has been reached. The power detector circuit can also be adapted to be used for a number of different electronic device configurations. The power detector circuit can be used to detect when the electronic device is operating under unsustainable conditions, and take action to alleviate the unsustainable conditions.

In some cases, a voltage regulator associated with the power detection circuit may have a voltage tolerance. A voltage tolerance, as referred to herein, may be specific to a type of voltage regulator, a manufacturer of a given voltage regulator, error in design, or as degradation over time, and the like. In other words, the voltage tolerance may be built-in to a given voltage regulator, and may be associated with an range of error in the output voltage. Therefore, the voltage tolerance may add an error in the detection of voltage associated with a given power detection. Typically, a small error in voltage detection may result in a comparatively large error in power detection. Therefore, the techniques described herein include a calibration module to identify a voltage tolerance associated with a given voltage regulator, and compensate for the voltage tolerance. The voltage tolerance may be described herein as a first voltage, or as a predefined voltage that may be referenced during calibration. During a reset sequence of a circuit, a low amount of voltage may be determined at the voltage regulator. The low amount of voltage may be referred to herein as a second voltage. The first voltage may be compared to the second voltage, and used to calibrate digital to analog (DAC) codes that are used in the power detection circuit described in more detail below.

The voltage regulators below are generally discussed as motherboard voltage regulators. However, the calibration techniques discussed may be implemented for any voltage regulator systems including voltage regulators having a loadline, voltage regulators not having a loadline, and the like.

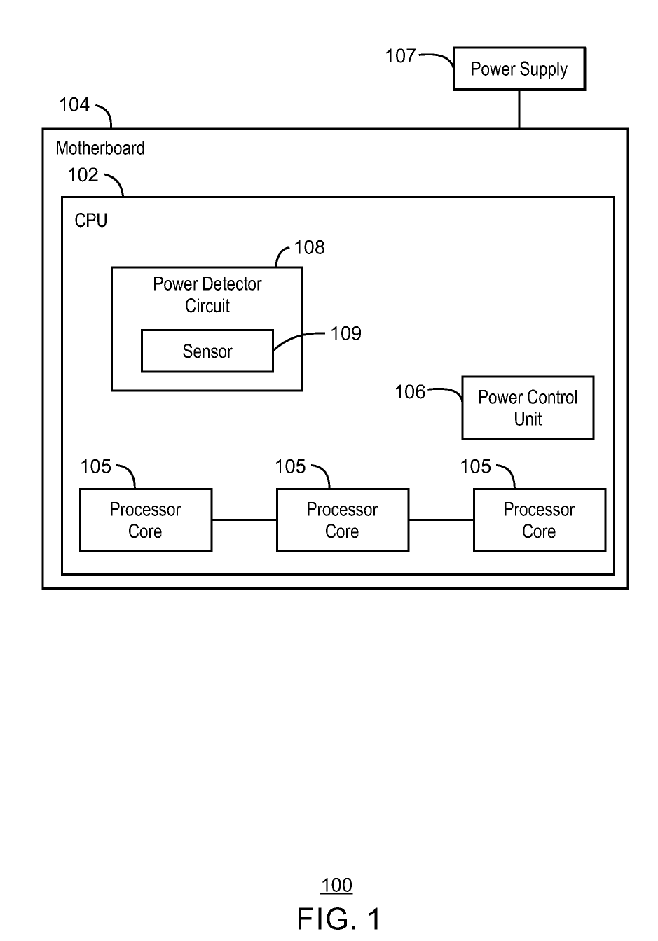

FIG. 1 is a block diagram of a system for power management and delivery in an electronic device. The system 100 can be used in an electronic device such as a server platform, a computer, a tablet, or a mobile phone. In some embodiments, the electronic device can utilize a multi-core processor.

The system 100 includes a central processing unit (CPU) 102 connected to a motherboard 104. The CPU 102 is used to run programs and applications, and may contain multiple processor cores 105. In some embodiments, the system 100 will utilize more than one CPU 102. A power control unit 106 is configured to deliver power to the one or more processor cores 102. The power control unit 106 can control the amount of power delivered to the one or more processor cores 102, and can throttle the one or more processor cores 102 in order to reduce power usage. The power control unit 106 can be coupled to or be contained in the CPU 102. A power supply 107 can deliver power to the motherboard.

A power detector circuit 108 can be coupled to the CPU 102 or the power control unit 106. The power detector circuit 108 is configured to measure how much power is being produced by the CPU 102 during operation. More specifically, a sensed voltage in the power detector circuit 108 can be measured at a sense point within the power detector circuit 108. In some embodiments, the sense point can be a sensor 109. If the sensed voltage is less than a pre-determined threshold, then the power detector circuit 108 can determine that a certain power condition has been detected. When the power condition has been detected, the power detector circuit 108 can send an alert to the power control unit 106, and command the power control unit 106 to throttle the one or more processor cores 102 to reduce power production.

The power condition can occur when a threshold of power produced is reached. In some embodiments, the threshold can be Pₘₐₓ, the maximum amount of power produced while a processor core 102 is running a power virus. In some embodiments, a user can set the threshold at a particular level, e.g. Pₐₚₚ.

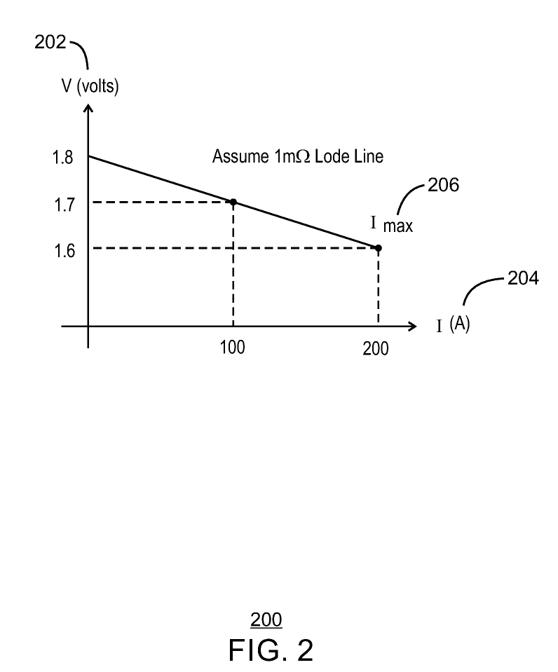

FIG. 2 is a graph illustrating the relationship between voltage and current in a power detector circuit. As is seen in the graph 200, the voltage 202 is proportional to the current 204. The current 204 can be supplied from a voltage regulator to a loadline in a circuit. The current 204 can represent the amount of power produced during CPU operation. Iₘₐₓ 206 represents the current at Pₘₐₓ, the maximum amount of power produced while a CPU is running a power virus.

In one example, the loadline of FIG. 2 has a resistance of 1 mΩ. A motherboard voltage regulator provides a nominal voltage of 1.8 V, which is the voltage at the end of the loadline when no current is present. When the current is at Iₘₐₓ (200 A), the voltage at the end of the loadline is 1.6 V.

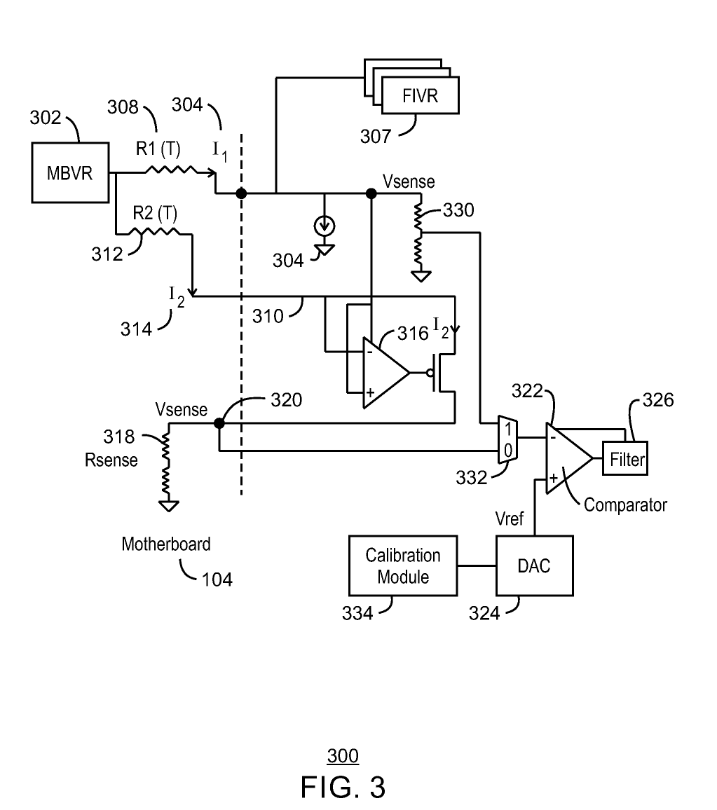

FIG. 3 is a diagram of an embodiment of a power detector circuit. The power detector circuit 300, which is an example of the power detector circuit 108 shown in FIG. 1, can monitor power production and notify a power control unit 106 if a certain power condition has been reached. The power detector circuit 300 is configured for current mode sensing. In current mode sensing, a regulator, such as a motherboard voltage regulator (MBVR) 302 supplies currents to a pair of circuit lines in order to cancel out temperature-related variance in the resistance of the circuit lines.

The MBVR 302 coupled to a motherboard 104 supplies a first current (I₁) 304 to a loadline which is represented by a first resistor (R₁(T)). The loadline 308 can represent connection from the MBVR to a CPU 102 in which the first current 304 is provided. In some cases, one or more fully integrated voltage regulators 307, or other power supplies such as direct supply transistors, power gates, and the like, may be provided.

A resistance value of the first resistor 308 may vary depending on temperature. A second line 310 with a second resistor (R₂(T)) 312 can be coupled to the loadline 308, such that a second current (I₂) 314 travels along the second line 310. The resistance value of the second resistor 312 may also vary depending on temperature. The first resistor 308 and the second resistor 312 have to be in close thermal proximity of one another, such that they both experience proportionally similar changes in resistance.

The loadline 308 and the second line 310 are coupled to an amplifier 316. The amplifier 316 can be used to force the voltage across the first resistor 308 and the voltage across the second resistor 312 to be equal. The end of the loadline 306 can be connected to the positive input of the amplifier 316, and the second line 310 can be coupled to the negative input of the amplifier 316. The amplifier 316 can be a low offset amplifier.

The output of the amplifier 316 is connected to a precision resistor (Rₛₑₙₛₑ) 318, which is located on the motherboard 104. The sensed voltage (Vₛₑₙₛₑ) across the precision resistor 318 can be measured by the power detector circuit 300 at a sense point 320 nearby. The sense point 320 is connected to an input of a comparator 322. The other input is connected to a digital-to-analog converter (DAC) 324, which is configured to provide a reference voltage (V_{ref}) to the comparator 322. The reference voltage may be the voltage level in which maximum power (Pₘₐₓ) occurs. The reference voltage may also be a user-defined voltage level. The DAC 324 can be coupled to the motherboard 104 or the power control unit 106.

The comparator 322 can compare the sensed voltage to the reference voltage. A filter 326 coupled to the output of the comparator 322 can detect if the sensed voltage falls below the reference voltage for a sustained amount of time. If the sensed voltage does fall below the reference voltage for a sustained amount of time, the power detector circuit 300 can send an alert to the power control unit 106 that a power condition has been reached, and command the power control unit 106 to throttle or slow down operation in one or more processor cores 102.

From the measured value of the sensed voltage and the known values of the resistors, the value of the first current can ultimately be calculated. The sensed voltage at the precision resistor 318 is caused by the second current 314. Therefore, the value of the second current 318 can be determined by in the following equation:

Vₛₑₙₛₑ=I₂ Rₛₑₙₛₑ

The amplifier 316 forces the voltage across the first resistor 308 and the voltage across the second resistor 312 to be equal. Thus, any change in resistance in the first resistor 308 due to temperature is effectively canceled out due to a proportionally equal change in resistance in the second resistor 312. Therefore, the value of the first current can be determined in the following equation:

I₁R₁=I₂R₂

In some cases, the power detector circuit 300 is configured for voltage mode sensing. In voltage mode sensing, MBVR 302 is used to cancel out temperature-related variance in a circuit line.

The MBVR 302 coupled to a motherboard 104 supplies the first current (I₁) 304 to a loadline 308, which is represented by the first resistor (R₁(T)). The loadline 308 can represent connection from the MBVR to a CPU 102 in which the first current 304 is provided. The resistance value of the load line 308 may vary depending on temperature. The loadline 308 may loop back to the MBVR 302, allowing the MBVR 302 to regulate and cancel any temperature-related changes in the resistance of the load line, shown as resistor 308.

The sensed voltage (Vₛₑₙₛₑ) at the end of the loadline 306 can be measured at a sense point 328. The sense point 328 is connected to an input of a comparator 322. The other input is connected to a digital-to-analog converter (DAC) 324, which is configured to provide a reference voltage (V_{ref}) to the comparator 322. The reference voltage may be the voltage level in which maximum power (Pₘₐₓ) occurs. The reference voltage may also be a user-defined voltage level. The DAC 324 can be coupled to the motherboard 104 or the power control unit 106.

In some embodiments, the comparator 322 may not be able to accept a high voltage. Thus, the sensed voltage may be reduced using a voltage divider 330 at the sense point 328. The voltage divider 330 may be a resistive divider, a low-pass RC filter, an inductive divider, or a capacitive divider. Accordingly, the reference voltage can be scaled down with the voltage ratio of the voltage divider 330.

In some embodiments, the power detector circuit 300 is configured to switch between current mode sensing and voltage mode sensing. In this case, a switch 332 that allows the power detector circuit 300 to change between the circuit configured for current mode sensing and the circuit configured for voltage mode sensing, as discussed above.

As discussed above, the comparator 322 can compare the sensed voltage to the reference voltage. In the embodiments described herein, the reference voltage is calibrated by a calibration module 334. In some cases, the calibration module 334 may be implemented as a finite state machine. In some cases, the calibration module 334 may be implemented as one or more of logic, hardware logic, electronic logic, software, firmware, and the like. In some cases, operations of the calibration module 334 may be combined as a broader process, separated into discrete processes, or any combination thereof. In any case, the calibration may be configured to identify a first voltage predefined for a voltage regulator, such as the MBVR 302. The predefined voltage may be referenced to compare to a second voltage occurring at the MBVR 302 during a reset sequence. A difference between the predefined voltage and the second voltage associated with the reset sequence may be used to calibrate DAC codes used at the comparator 322. For example, a DAC code indicating the calibrated referenced voltage may be the DAC code associated with a given power level, such as Pₘₐₓ, minus the difference between the predefined voltage and the second voltage determined during the reset sequence.

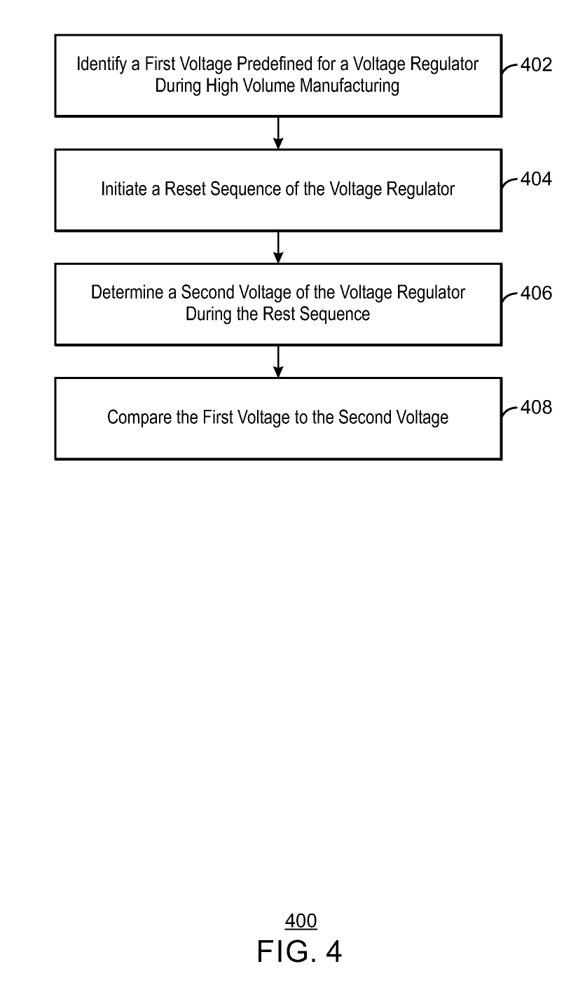

FIG. 4 is a process flow diagram of a method for voltage regulator calibration. At block 402, the method 400 identifies a first voltage predefined for a voltage regulator during high volume manufacturing. At block 404, the method initiates a reset sequence. At block 406, the method 400 determines a second voltage of the voltage regulator during the reset sequence. At block 408, the method 400 compares the first voltage to the second voltage.

The reset sequence may be associated with testing during high volume manufacturing. For example, a processor associated with a given circuit may be calibrated on a tester during high volume manufacturing for a particular voltage expected from the voltage regulator. During a power on sequence (reset sequence) of the processor on the motherboard may occur. The first voltage is predefined and the second voltage is identified during the reset sequence and is based on voltage tolerance for the voltage regulator being tested.

In some cases, comparing the first voltage to the second voltage is performed using a finite state machine. In some cases, the method further includes defining an error based on the comparison between the first voltage and the second voltage. In some cases, the error is determined by calculating a difference between the first voltage and a second voltage. The first voltage may be considered a nominal voltage in some cases, and the second voltage is associated with a reset sequence.

In some cases, the method 400 includes measuring a sensed voltage at a sense point coupled to the loadline, comparing the sensed voltage to a reference voltage, and sending an alert that a power condition has been reached in response to determining that the sensed voltage is less than the reference voltage. The alert may indicate indicates that a power virus is operating processor core coupled to the motherboard voltage regulator. In some cases, detecting when the sensed voltage is less than the reference voltage for a sustained period of time and the alert may be sent out only after the sustained period of time is met or passed. Further, the referenced voltage may be calibrated based the difference between the first voltage and the second voltage.

In some cases, the method 400 includes canceling out temperature-related variance in the resistance of a loadline in the circuit. In some cases, the method includes switching between a voltage mode sensing and a current mode sensing.

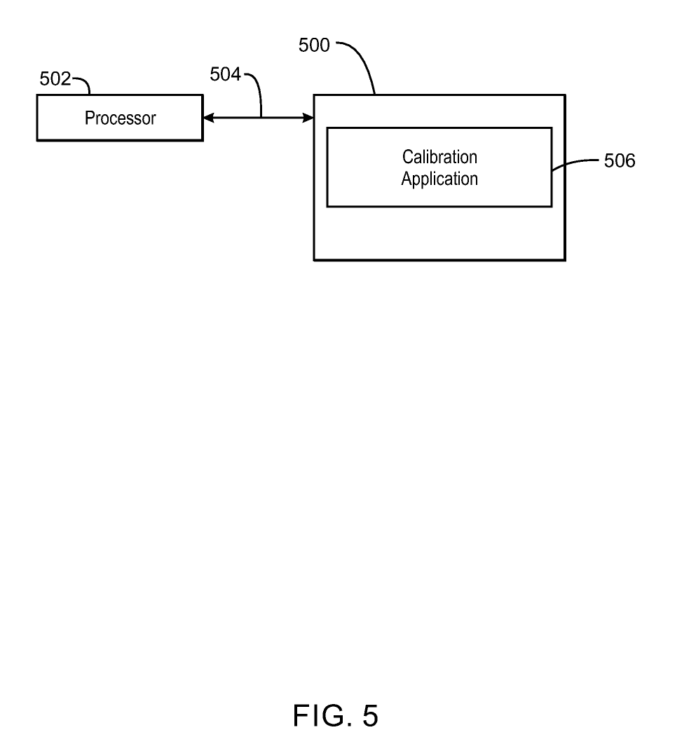

FIG. 5 is a block diagram depicting an example of a computer-readable medium configured to implement calibration. The computer-readable medium 500 may be accessed by a processor 502 over a computer bus 504. In some examples, the computer-readable medium 500 may be a non-transitory computer-readable medium. In some examples, the computer-readable medium may be a storage medium. However, in any case, the computer-readable medium does not include transitory media such as carrier waves, signals, and the like. Furthermore, the computer-readable medium 500 may include computer-executable instructions to direct the processor 502 to perform the steps of the current method.

The various software components discussed herein may be stored on the tangible, non-transitory, computer-readable medium 500, as indicated in FIG. 5. For example, a calibration application 506 may be configured to identify a first voltage predefined for a voltage regulator and to determine a second voltage of the voltage regulator during a reset sequence. The calibration application 506 may be further configured to compare the first voltage to the second voltage.

Examples may include subject matter such as a method, means for performing acts of the method, at least one machine-readable medium including instructions that, when performed by a machine cause the machine to performs acts of the method. It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

Example 1 includes a circuit. The circuit includes a voltage regulator and a calibration module. The calibration module includes logic, at least partially including hardware logic to identify a first voltage predefined for the voltage regulator, determine a second voltage at the voltage regulator during a reset sequence, and compare the first voltage to the second voltage.

In Example 1, the circuit may include any combination of the cases discussed below. In some cases, the logic of the calibration module comprises a finite state machine. Further, in some cases, the logic of the calibration module is to define an error based on a difference between the first voltage and the second voltage. In yet other cases, the voltage regulator does not use a load line.

In further cases, the voltage regulator is a motherboard voltage regulator to supply a current to a loadline. The circuit may further include a sense point coupled to the loadline, the circuit to measure a sensed voltage at the sense point, a comparator to compare the sensed voltage to a reference voltage, and a power control unit to throttle the processor core if the sensed voltage is below the reference voltage. The reference voltage can be calibrated based on the difference between the first voltage and the second voltage. The circuit may further include a second line coupled to the motherboard voltage regulator, a precision resistor at the sense point, and an amplifier to cancel out temperature-related variation in the resistance of the loadline. The loadline and the second line are each coupled to an input of the amplifier, and the precision resistor is coupled to the output of the amplifier. The circuit may also include a switch to change between a voltage mode sensing and a current mode sensing, and a digital-to-analog converter (DAC) coupled to an input of the comparator. The DAC may be configured to provide a value of the reference voltage. In some cases, the circuit may include a filter coupled to the output of the comparator. The filter can be configured to detect when the sensed voltage is less than the reference voltage for a sustained period of time.

Example 2 includes a method for calibration. The method includes identifying a first voltage predefined for a voltage regulator, initiating a reset sequence, determining a second voltage at the voltage regulator during the reset sequence, and comparing the first voltage to the second voltage.

In Example 2, the method may include any combination of the cases discussed below. In some cases, comparing the first voltage to the second voltage is performed at a finite state machine. In some cases, the method further includes defining an error based on the comparison between the first voltage and the second voltage. The error is determined by a calculating a difference between the first voltage and the second voltage.

In some cases, the voltage regulator is a motherboard voltage regulator to supply a current to a loadline. In this scenario, the method further includes measuring a sensed voltage at a sense point coupled to the loadline, comparing the sensed voltage to a reference voltage, and sending an alert that a power condition has been reached in response to determining that the sensed voltage is less than the reference voltage. The method may further include calibrating the reference voltage based on the difference between the first voltage and the second voltage. The method may also include canceling out temperature-related variance in the resistance of a loadline in the circuit. The method may also include detecting when the sensed voltage is less than the reference voltage for a sustained period of time. In some cases, the alert indicates that a power virus is operating processor core coupled to the motherboard voltage regulator.

Example 3 includes a computer-readable storage medium. The computer-readable storage medium includes code to direct a processor to identify a first voltage of predefined for a voltage regulator, determine a second voltage at the voltage regulator during a reset sequence, and compare the first voltage to the second voltage.

In Example 3, the computer-readable storage medium may include any combination of code related to cases discussed below. In some cases, the logic of the code comprises a finite state machine. In some cases, the code is to define an error based on a difference between the first voltage and the second voltage. In some cases, the voltage regulator does not use a load line.

In some cases, the voltage regulator is a motherboard voltage regulator to supply a current to a loadline of a circuit. The circuit may further include a sense point coupled to the loadline, the circuit to measure a sensed voltage at the sense point, a comparator to compare the sensed voltage to a reference voltage, and a power control unit to throttle the processor core if the sensed voltage is below the reference voltage. The reference voltage can be calibrated based on the difference between the first voltage and the second voltage. The circuit may further include a second line coupled to the motherboard voltage regulator, a precision resistor at the sense point, and an amplifier to cancel out temperature-related variation in the resistance of the loadline. The loadline and the second line are each coupled to an input of the amplifier, and the precision resistor is coupled to the output of the amplifier. The circuit may also include a switch to change between a voltage mode sensing and a current mode sensing, and a digital-to-analog converter (DAC) coupled to an input of the comparator. The DAC may be configured to provide a value of the reference voltage. In some cases, the circuit may include a filter coupled to the output of the comparator. The filter can be configured to detect when the sensed voltage is less than the reference voltage for a sustained period of time.

Example 4 includes a circuit. The circuit includes a voltage regulator and a means for calibration. The means for calibration is to identify a first voltage predefined for the voltage regulator, determine a second voltage at the voltage regulator during a reset sequence, and compare the first voltage to the second voltage.

In Example 4, the circuit may include any combination of the cases discussed below. In some cases, logic of the means for calibration is a finite state machine. Further, in some cases, the logic of the means for calibration is to define an error based on a difference between the first voltage and the second voltage. In yet other cases, the voltage regulator does not use a load line.

In further cases, the voltage regulator is a motherboard voltage regulator to supply a current to a loadline. The circuit may further include a sense point coupled to the loadline, the circuit to measure a sensed voltage at the sense point, a comparator to compare the sensed voltage to a reference voltage, and a power control unit to throttle the processor core if the sensed voltage is below the reference voltage. The reference voltage can be calibrated based on the difference between the first voltage and the second voltage. The circuit may further include a second line coupled to the motherboard voltage regulator, a precision resistor at the sense point, and an amplifier to cancel out temperature-related variation in the resistance of the loadline. The loadline and the second line are each coupled to an input of the amplifier, and the precision resistor is coupled to the output of the amplifier. The circuit may also include a switch to change between a voltage mode sensing and a current mode sensing, and a digital-to-analog converter (DAC) coupled to an input of the comparator. The DAC may be configured to provide a value of the reference voltage. In some cases, the circuit may include a filter coupled to the output of the comparator. The filter can be configured to detect when the sensed voltage is less than the reference voltage for a sustained period of time.

Example 5 includes a system for calibration of a voltage regulator of a circuit. The system includes a voltage regulator and a means for calibration. The means for calibration is to identify a first voltage predefined for the voltage regulator, determine a second voltage at the voltage regulator during a reset sequence, and compare the first voltage to the second voltage.

In Example 5, the system may include any combination of the cases discussed below. In some cases, logic of the means for calibration is a finite state machine. Further, in some cases, the logic of the means for calibration is to define an error based on a difference between the first voltage and the second voltage. In yet other cases, the voltage regulator does not use a load line.

In further cases, the voltage regulator is a motherboard voltage regulator to supply a current to a loadline. The system may further include a sense point coupled to the loadline, the circuit to measure a sensed voltage at the sense point, a comparator to compare the sensed voltage to a reference voltage, and a power control unit to throttle the processor core if the sensed voltage is below the reference voltage. The reference voltage can be calibrated based on the difference between the first voltage and the second voltage. The system may further include a second line coupled to the motherboard voltage regulator, a precision resistor at the sense point, and an amplifier to cancel out temperature-related variation in the resistance of the loadline. The loadline and the second line are each coupled to an input of the amplifier, and the precision resistor is coupled to the output of the amplifier. The system may also include a switch to change between a voltage mode sensing and a current mode sensing, and a digital-to-analog converter (DAC) coupled to an input of the comparator. The DAC may be configured to provide a value of the reference voltage. In some cases, the system may include a filter coupled to the output of the comparator. The filter can be configured to detect when the sensed voltage is less than the reference voltage for a sustained period of time.

Although some embodiments have been described in reference to particular implementations, other implementations are possible according to some embodiments. Additionally, the arrangement and order of circuit elements or other features illustrated in the drawings or described herein need not be arranged in the particular way illustrated and described. Many other arrangements are possible according to some embodiments.

In each system shown in a figure, the elements in some cases may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment”, “one embodiment,” “some embodiments”, or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A circuit, comprising:
a voltage regulator;
a calibration module comprising logic, at least partially comprising hardware logic to:
identify a first voltage predefined for the voltage regulator;
determine a second voltage at the voltage regulator during a reset sequence; and
compare the first voltage to the second voltage.

2. The circuit of claim 1, wherein the logic of the calibration module comprises a finite state machine.

3. The circuit of claim 1, wherein the logic of the calibration module is to define an error based on a difference between the first voltage and the second voltage.

4. The circuit of claim 1, wherein the voltage regulator does not use a load line.

5. The circuit of claim 1, wherein the voltage regulator is a motherboard voltage regulator to supply a current to a loadline, the circuit further comprising:
a sense point coupled to the loadline, the circuit to measure a sensed voltage at the sense point;
a comparator to compare the sensed voltage to a reference voltage; and
a power control unit to throttle the processor core if the sensed voltage is below the reference voltage.

6. The circuit of claim 5, wherein the reference voltage is calibrated based on the difference between the first voltage and the second voltage.

7. The circuit of claim 6, the circuit comprising:
a second line coupled to the motherboard voltage regulator;
a precision resistor at the sense point; and
an amplifier to cancel out temperature-related variation in the resistance of the loadline, wherein the loadline and the second line are each coupled to an input of the amplifier, and the precision resistor is coupled to the output of the amplifier.

8. The circuit of claim 7, the circuit comprising a switch to change between a voltage mode sensing and a current mode sensing.

9. The circuit of claim 6, the circuit comprising a digital-to-analog converter (DAC) coupled to an input of the comparator, the DAC to provide a value of the reference voltage.

10. The circuit of claim 6, the circuit comprising a filter coupled to the output of the comparator, the filter to detect when the sensed voltage is less than the reference voltage for a sustained period of time.

11. A method, comprising:
identifying a first voltage predefined for a voltage regulator;
initiating a reset sequence;
determining a second voltage at the voltage regulator during the reset sequence; and
comparing the first voltage to the second voltage.

12. The method of claim 11, wherein comparing the first voltage to the second voltage is performed at a finite state machine.

13. The method of claim 11, the method further comprising defining an error based on the comparison between the first voltage and the second voltage.

14. The method of claim 13, wherein the error is determined by a calculating a difference between the first voltage and the second voltage.

15. The method of claim 14, wherein the voltage regulator is a motherboard voltage regulator to supply a current to a loadline, the method further comprising:
measuring a sensed voltage at a sense point coupled to the loadline;
comparing the sensed voltage to a reference voltage; and
sending an alert that a power condition has been reached in response to determining that the sensed voltage is less than the reference voltage.

16. The method of claim 15, wherein the method further comprising calibrating the reference voltage based on the difference between the first voltage and the second voltage.

17. The method of claim 16, the method comprising canceling out temperature-related variance in the resistance of a loadline in the circuit.

18. The method of claim 17, the method comprising switching between a voltage mode sensing and a current mode sensing.

19. The method of claim 15, wherein the alert indicates that a power virus is operating processor core coupled to the motherboard voltage regulator.

20. The method of claim 16, the method comprising detecting when the sensed voltage is less than the reference voltage for a sustained period of time.

21. A computer-readable storage medium comprising code to direct a processor to:
identify a first voltage of predefined for a voltage regulator;
determine a second voltage at the voltage regulator during a reset sequence; and
compare the first voltage to the second voltage.

22. The computer-readable storage medium of claim 21, further comprising code to direct the processor to define an error based on the comparison between the first voltage and the second voltage, wherein the error is determined by a calculating difference between the first voltage and the second voltage.

23. The computer-readable storage medium of claim 22, wherein the voltage regulator is a motherboard voltage regulator to supply a current to a loadline, the further comprising code to direct the processor to:
measure a sensed voltage a sense point coupled to the loadline; and
compare the sensed voltage to a reference voltage;
send an alert that a power condition has been reached in response to determining that the sensed voltage is less than the reference voltage.

24. The computer-readable storage medium of claim 23, wherein the reference voltage is calibrated based on the difference between the first voltage and the second voltage.

25. The computer-readable storage medium of claim 24, wherein the code of comprises a finite state machine.
